(19) United States
(12) Patent Application Publication
(10) Pub. No.: US 2015/0075234 A1
(43) Pub. Date: Mar. 19, 2015

(54) Separate Front and Rear Bicycle Bike Bolt Locks and Combination Locking Mechanism

(71) Applicant: Edward DiNapoli, Plainview, NY (US)

(72) Inventor: Edward DiNapoli, Plainview, NY (US)

(21) Appl. No.: 14/153,985

(22) Filed: Jan. 13, 2014

Related U.S. Application Data
(60) Provisional application No. 61/879,814, filed on Sep. 19, 2013.

(51) Int. Cl. E05B 71/00

(52) U.S. Cl. CPC E05B 71/00
USPC 70/233

(57) ABSTRACT

A deadbolt lock is utilized to lock a turned wheel in place at an angle from its ordinary orientation. Perforations in the holy smoke tube match perforation in the head tube whereupon the bolt from the keyed lock may be inserted upon turning of a key. A rear wheel friction lock is provided having a member having a deadbolt lock that extends a frictional rubber device to make contact and block further rotation of the tire. Finally, a dual rack and pinion system has a key lock activated pinion articulating oppositely operating rack members; a pin or bolt lock blocks front tire and wheel movement and a hinged friction lock blocks rear tire and wheel motion.

### FIELD OF THE INVENTION

The present invention relates to a bike locking mechanism; more specifically, the present invention relates to separate front and rear bike locks and the combination of a front and rear bike lock working together.

### BACKGROUND OF THE INVENTION

EP Application Pub. EP 0 192 467 Published 27.08.86 Application 86301139.1 filed 19.02.86

The aforementioned European Patent Application described a novel locking mechanism that teaches a rack key locking system as described below.

The publication refers to improvements in a rack and pinion system for activating lock cylinder units.

This enables the lock cylinder unit to be retained against rotating movement by a plurality of discs oscillating about its shaft and provided with a toothed section, a segmented area of each of them being housed in openings at corresponding points of a fixed sleeve of the cylinder unit. The said discs are disposed in plates radial to the cylinder unit shaft, secured at their axial ends to circular supports.

The release position of the lock cylinder unit, so that it can rotate freely, is obtained by inserting, axially to the cylinder unit, the corresponding key provided with a plurality of racks disposed longitudinally at at least one of the faces of its polygonal profile, which racks are capable of meshing with the corresponding teeth of the discs; causing them to rotate to a maximum penetration position of the key at which segmented offsets of the discs coincide with the open-in6s of the fixed sleeve. At this position there are no means for retaining the cylinder unit against rotation.

Each of the discs is impelled by a spring which maintains it in an angular position fixed by a butt, in order to enable insertion of the key and so that the initial tooth of each of its racks impinges correctly on the first tooth of the disc, without causing any obstruction or blocking between teeth.

The wide range of lock cylinder units and corresponding keys is achieved by varying the number of teeth of at least one of the key racks, since this has a bearing on the final position adopted by the corresponding disc, and therefore its segmented offset, enabling the cylinder unit to rotate freely, should be placed at a different position. According to the teachings herein, and to highly increase the different combinations of lock cylinder units and keys, the pitch of at least one of the rack and pinion gears must differ from that of the rest. Further, the teeth of at least one of the key racks can be disposed in a lineally offset position from those of the rest.

According to the teachings herein, the discs provided with a toothed area are preferably placed at both sides of the radial plates, oscillating about a common shaft which passes through them, the said discs being angularly positioned so that the first tooth, on which the key impinges, is firmly positioned by the said butt, close to the shaft of the lock cylinder unit and coinciding therefore with that of the operating key. In accordance with this arrangement of the discs, the racks of the key will be positioned in pairs, their teeth having the same or a different pitch, as well as also slight-ly offset, as already indicated.

The disc support plates are preferably arranged according to two perpendicular planes, so that their inner edges are close to the shaft, emerging from the discs, wherefore the key will adopt a general square section and will be provided with four longitudinal notches constituting the guiding means for the insertion thereof, since the longitudinal edges of the said support plates slide there along.

FIG. 1 is an elevational view of one of the support plates of the partially toothed discs, corresponding to a position at which the lock cylinder unit is retained against rotation, and also showing the key of the actuating system of the teachings herein.

FIG. 2 is a section on line A-B of FIG. 1.

FIG. 3 is a fragmentary perspective view showing the fastening of the radial support plates of the discs to end circular supports, thereby determining the solid frame of the lock cylinder unit.

FIG. 4 is a cross-section of the lock cylinder unit of FIG. 3, including the discs and the fixed sleeve of the cylinder unit.

FIG. 5 is a partial section of the operating key of the teachings herein.

FIG. 6 is a section on line C-D of FIG. 5.

FIG. 7 is a perspective view of the fixed sleeve of the lock cylinder unit, illustrating the openings constituting the means for retaining the cylinder unit against rotation.

Referring to the drawings, it can be seen that the rack and pinion system for activating lock cylinder units is comprised of a plurality of discs 1 provided at a partial area of their periphery with teeth 2, each one of which has a segmented offset defining a straight line 3 at a relative position with respect to the teeth 2, some discs differing from others. The discs 1 are preferably disposed in pairs and are rotatably supported at both sides of a plurality of support plates 4 disposed radially to the shaft of the lock cylinder unit, which plates are fixed at their ends 5 to axially-holed circular supports 6. According to a preferred embodiment of the teachings herein, there are four radial support plates 4 disposed according to two perpendicular planes, although any other arrangement having a higher or lesser number of support plates and preferably arranged in a uniform angular position could be adopted.

Referring to FIG. 3, the support plates 4 are fixed to the circular supports 6 provided with the axial hole 7, the assembly being secured by screws 8 passing through holes 9 of a member 10 placed in a backed relation with the outer face of the inner circular support 6, and through corresponding holes 11 of said circular supports 6, the end of said screws 8 en-engaging in threaded holes of another end member 12 placed in a backed relation with the outermost circular support 6 and provided with the axial hole 13 for inserting the key 14.

The assembly of elements through which the screws 8 pass, forms a compact assembly constituting the rotary frame of the lock cylinder unit.

According to FIGS. 1 and 2, each support plate 4 includes two discs 1 backed to their faces and oscillating about a common shaft 15 which passes through the support plate 4. The shaft 15 is retained against axial movement since its ends are provided with annular slots 16 into which the end lugs 17 and 18 of one of the ends of abutting members 19 are introduced, the opposite end of which is secured to the support plate 4 by means of a pin 20.

Each abutting member 19 therefore has the dual purpose of, on the one hand, preventing the common shaft 15, for turning two discs 1, from emerging and, on the other hand, fixing the angular position of the teeth 2 of the disc 1, when the pivot 21 emerging from the outer face of the disc 1, since it is aided by a spring 22, contacts its edge radially furthermost from the shaft of the cylinder unit.

According to FIG. 1, each disc 1 has an area in the form of a circular segment 23 which emerges from the radially furthermost longitudinal edge 24 of the support plate 4. Upon insertion of the key 14 through the opening of the end member 12 of the lock cylinder unit, the first tooth 25 of the corresponding rack 26, provided longitudinally in the key 14 and cap-able of meshing with the teeth 2 of the corresponding disc 1, impinges on the first tooth 2 thereof, causing an angular displacement of the disc in which, at the position corresponding to that of maximum penetration of the key 14, the segmented offset 3 of the disc 1 occupies the position shown at 27 in FIG. 1, at which it is joined to the upper edge 24 of the support plate 4.

As can be seen from FIGS. 4 and 7, as long as the lock is not activated by the corresponding key, the discs 1 present a circular segment 23, emerging from its support plate 4, this circular segment 23 being housed in the corresponding housing 28 made in the direction of the generators of a sleeve 29 of the cylinder unit frame, which remains fixed and therefore stationary with respect to the cylinder unit, thereby constituting the blocking means for the lock.

The housings 28 of the fixed sleeve 29 are formed of rectangular windows uniformly arranged on the circular periphery of the sleeve. In the embodiment shown in the figures, they are arranged in pairs, there-fore forming, between each two consecutive pairs, a small stiffening partition 30 which insures the entire stable position and a maximum resistance against a possible fraudulent action due to the rotation of the cylinder unit.

Referring to FIG. 4, the eight discs 1 are partially housed in the corresponding housings 28 of the sleeve 29, the cylinder unit therefore being retained against rotation or being encountered at a block-ing position. FIG. 4 also illustrates that the free edge 24 of the support plate 4 is positioned close to the inner surface of the sleeve 29, whereas its innermost edge is very close to the lock cylinder unit.

According to FIGS. 5 and 6 illustrating the key, it can be seen that the profile has a polygonal shape, adapted to the number of support plates 4 of the cylinder unit shaft, said profile having a like number of notches 31 defining guiding means for the insertion of the key, since the innermost edge of the support plates 4 is housed in said notches 31 (see FIGS. 1 and 4). At the maximum insertion position of the key 14, that is when the front end 32 thereof butts against the end member 10 of the lock cylinder unit, all the segments 3 or offsets of the discs 1 are positioned according to the dotted line 27 of FIG. 1, prolonging from the upper edge 24 of the support plates 4, where-by the housings 28 of the sleeve 29 of the cylinder unit are free from the disc 1, thereby eliminating the blocking means for the lock cylinder unit to turn freely.

Each of the racks 26 disposed in the key 14 has a different number of teeth 25, so that, until the maximum insertion position of the key is reached, a different angular displacement will be produced in each one of the discs, or at least in some of them, wherefore the segmented offset 3 of each of the discs 1 is made at a relative position in accordance with the angular magnitude of the rotation. Apart from the different number of teeth of the racks 26 of the key 14, the pitch of the rack and pinion gear of some of the discs 1 and their respective rack 26 can also vary, end further, although all the racks have the same pitch, the teeth of some of them can be offset from the teeth of others, enabling the number of possible combinations in the formation of the range of locks to be highly increased and preventing the same manufactured unit from being repeated.

Since the teeth of the racks 26 intervening in the rotation of the respective discs 1 are those positioned close to the end 32 for the insertion of the key, the said racks can depart from the same front surface 33 close to the widening 34 for securing the key, since this arrangement is not related to the functioning.

As can be seen from FIG. 4, the fixed sleeve 29 of the lock cylinder unit is, in turn, covered with another steel sleeve 35 which conceals the housings 25 of the former, to prevent access to the discs 1 as well as a fraudulent action.

Upon extraction of the key 14, all the discs 1 recover their original position to enable the key 14 to be re-inserted by means of springs 22.

If a key 14 differing from that corresponding to the cylinder unit, because it has a different gear pitch or an offset arrangement of the racks, is inserted, the assembly will normally be blocked because of jamming, and it will not be possible to completely insert the key or to extract it thereafter, if insertion has been forced. In the case of a very simple arrangement of racks and partially toothed discs, even though the key could be completely inserted, one area of each of the discs will always be housed in the corresponding housing of the fixed sleeve, therefore preventing the cylinder unit from rotating freely, which effect is achieved only when the corresponding key is inserted and all the discs rotate in the adequate angular magnitude.

### Bike Locks

Bike locks come in a variety of sizes and shapes. The most reliable and effective tend to be those locks that are least portable and most expensive. Amongst the various types of existing bike locks are the U-locks and D-locks, chain, cable, wheel and locking skewers.

The so-called U-lock is a rigid metal ring that is formed like the letter U. A crossbar portion attaches to the U part of the lock. The attachment of the crossbar portion makes the entire device appear to be in the shape of a letter D. In order to secure the bike a user attaches it to some other object, such as a bike rack, parking meter or a flagpole or similar structure.

A chain lock has a predetermined length of chain that has a lock attached at a link of the chain; the lock is typically a combination or key based lock. If there is sufficient length the chain can pass through both wheels, the bike frame and fix it to an immovable object such as a rack, pole or meter. Since chains are easy to manipulate and rearrange around objects, they are easier to lock about then the D locks.

Another type of bike locking mechanism is a cable lock. These share some similarities to chain locks in that they have a locking mechanism attached to a length of flexible material. Cable locks usually have a lock already permanently integrated with the cable so as to ensure proper attachment of the bike. Alternatively, a length of cable with loops on both ends is used to thread the lock therethrough. The main advantage of cable locks over chains is that they are more portable then chain locks.

Next, a wheel lock also known as an O-lock or ring-lock, is a low security mechanism mounted on the frame that prevents motion of the rear wheel by moving a metal rod through the bike spokes to prevent rotation of the aforementioned.

Finally, locking skewers replace the existing quick release skewers on a bicycle's wheels and seat post clamp.

A criminal with a cutting mechanism can simply break the chain, cable, metal part and pedal away or load the bike in the back of a truck and drive away. Thus, cable, chain, D, skewer and wheel locking mechanisms are easily breakable by a delinquent and do not provide sufficient protection for the bicycle. Accordingly, there needs to be some solution to overcome the aforementioned problem.

### SUMMARY OF THE INVENTION

The present invention overcomes the deficiencies of the known art and the problems that remain unsolved by providing the following:

A bicycle locking system comprising:

a deadbolt lock attached to

a tubular member of the bicycle.

In another aspect, a rotating member situated within the tubular member.

In another aspect, a perforation on one side of the tubular member.

In another aspect, a first perforation in the rotating member.

In another aspect, a second perforation in the rotating member.

In another aspect, wherein the first and second perforation are disposed on opposite sides of the rotating member.

In another aspect, wherein the first and second perforation are disposed at angle apart from each other on the rotating member.

In another aspect, wherein the angle creates a chord between the first and second perforation.

In another aspect, wherein the tubular member is the head tube of the bike.

In another aspect, a bike locking mechanism comprising:
a bike having
a top tube and
a linear frictional member attached at an end of the top tube.

In another aspect, a deadbolt lock attached to the linear frictional member.

In another aspect, wherein the deadbolt lock further comprises: a bolt exiting the locking mechanism.

In another aspect, wherein the bolt exiting the locking mechanism further comprises an end plate.

In another aspect, further comprising a rubber device attached to the end plate.

In another aspect, a bike locking apparatus comprising:
a bike having
a top tube and
a front locking device inserted within the top tube.

In another aspect, a rear locking device inserted within the top tube and operable in conjunction with the front locking device.

In another aspect, wherein the front locking device further comprises:
a rack and pinion system.

In another aspect, wherein the rear locking device further comprises:
a rack and pinion system.

In another aspect, wherein the front locking device and the rear locking device further comprise:
a top rack associated with one device and bottom rack associated with the other device.

In another aspect, a pinion attached to and operable from a keyed locking mechanism to rotatable actuate the bottom and top rack devices.

These and other aspects, features, and advantages of the present invention will become more readily apparent from the attached drawings and the detailed description of the preferred embodiments, which follow.

### BRIEF DESCRIPTION OF THE DRAWINGS

The preferred embodiments of the invention will hereinafter be described in conjunction with the appended drawings provided to illustrate and not to limit the invention, in which:

FIG. 1 presents an elevational view of one of the support plates of the partially toothed discs, corresponding to a position at which the lock cylinder unit is retained against rotation, and also showing the key of the actuating system of the EP patent publication of the prior art.

FIG. 2 is a section on line A-B of FIG. 1 of the EP patent publication of the prior art.

FIG. 3 is a fragmentary perspective view showing the fastening of the radial support plates of the discs to end circular supports, thereby determining the solid frame of the lock cylinder unit of the EP patent publication of the prior art.

FIG. 4 is a cross-section of the lock cylinder unit of FIG. 3, including the discs and the fixed sleeve of the cylinder unit of the EP patent publication of the prior art.

FIG. 5 is a partial section of the operating key of the teachings of the prior art.

FIG. 6 is a section on line C-D of FIG. 5 of the EP patent publication of the prior art.

FIG. 7 is a perspective view of the fixed sleeve of the lock cylinder unit, illustrating the openings constituting the means for retaining the cylinder unit against rotation of the EP patent publication of the prior art.

FIG. 8A presents a side view of a novel front lock according to an embodiment. FIG. 8B presents a view of a novel front bike lock according to an embodiment. FIG. 8C presents an isometric view of a portion of the tubular structure of the bike having holes for practicing an embodiment. FIG. 8D presents a top cross section view of the top portion of the holysmoke. FIG. 8E shows an assembled cross section of the front tubular structure of a novel front bike lock according to an embodiment. FIG. 8F shows a novel front lock once the bolt or pin has been extended according to an embodiment.

FIG. 9A presents a side view of a novel bicycle rear lock according to an embodiment. FIG. 9B illustrates a rear view of a novel rear bike lock according to an embodiment. FIG. 9C illustrates a retracted bolt locking arm of a novel rear bike lock according to an embodiment. FIG. 9D shows an extended bolt locking arm of a novel rear bike lock according to an embodiment.

FIG. 10A presents an isometric side view of a barrel of a novel bike lock according to an embodiment showing the toothed gear at the end of the barrel for turning the front and rear racks. FIG. 10B shows a side view of interior side wall of a bike tube having a protrusion forming a rotational axis for the barrel and toothed gear. FIG. 10C illustrates a right side view of a set of front and rear racks of a novel bike lock according to an embodiment. FIG. 10D shows a left cross section view of a set of front and rear racks inside a top tube of a novel bike lock according to an embodiment. FIG. 10E shows a left cross section side view of a bike showing the rack mechanism inside of a top tube for a novel bike lock according to an embodiment. FIG. 10F shows a front bolt lock of a novel bike lock according to an embodiment as the locking mechanism enters the front tube walls. FIG. 10G illustrates a left side isometric view of tubular device having a rack used to create a front lock according to an embodiment. FIG. 10H shows a left side isometric view of a tubular device having a rack used to make a rear lock in combination with a friction member according to an embodiment. FIG. 10I is a swivel joint for a rear friction lock according to an embodiment. FIG. 10J is a side view of a friction member according to an embodiment.

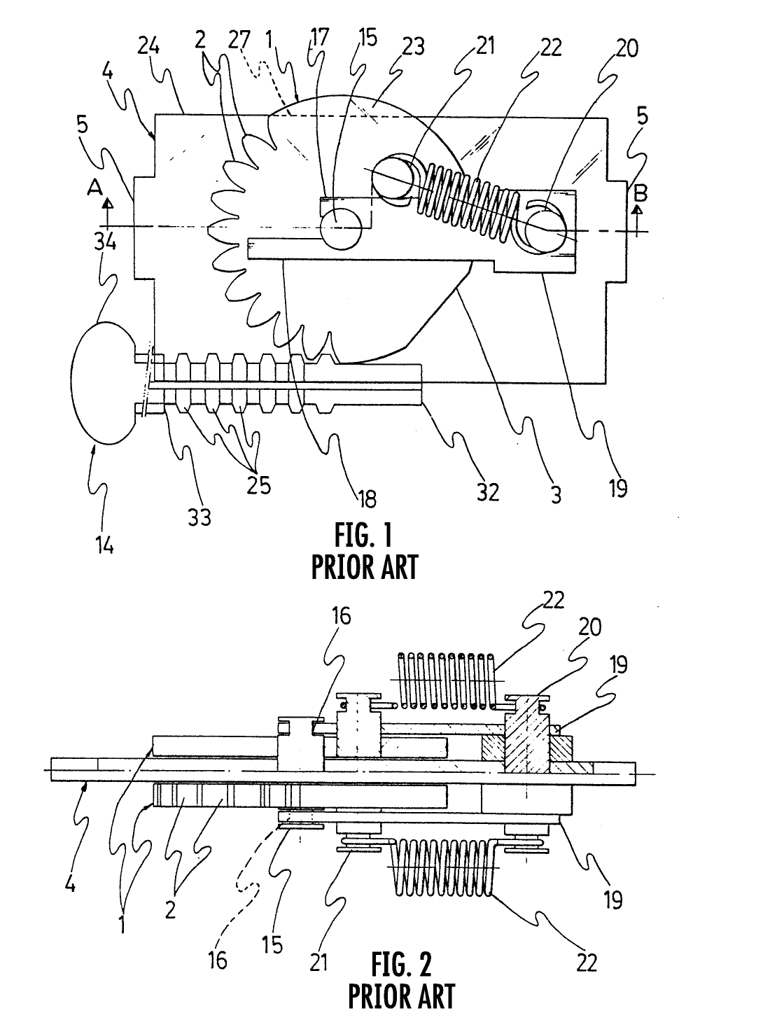

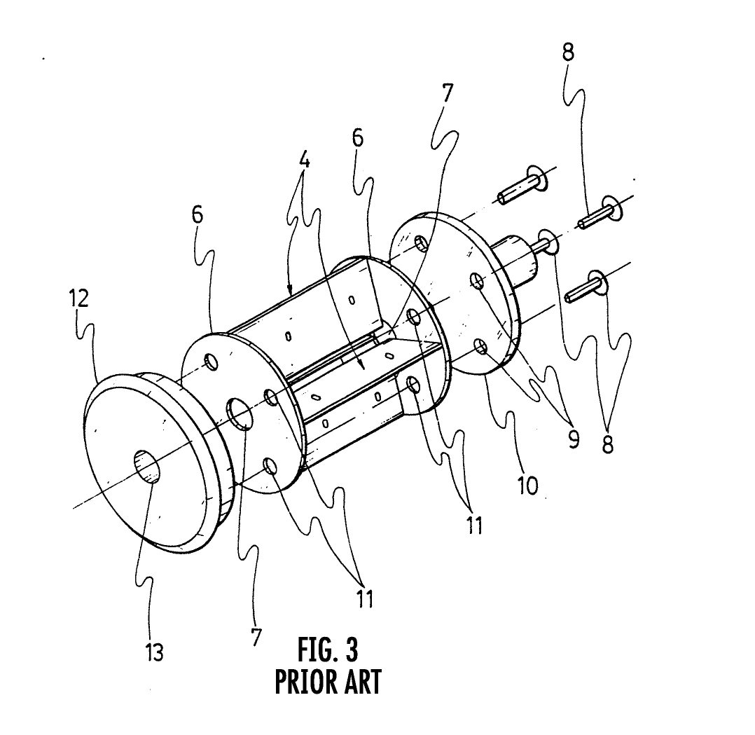

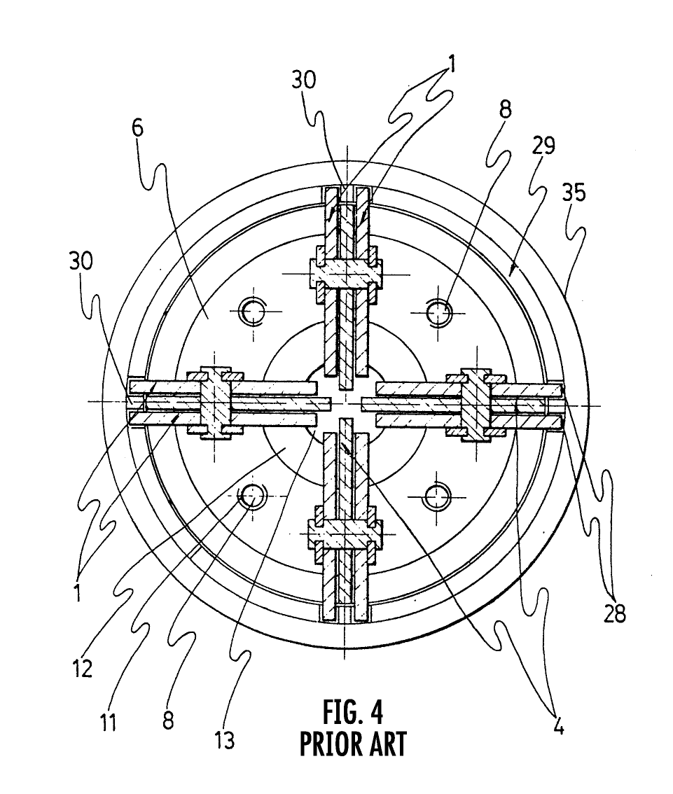

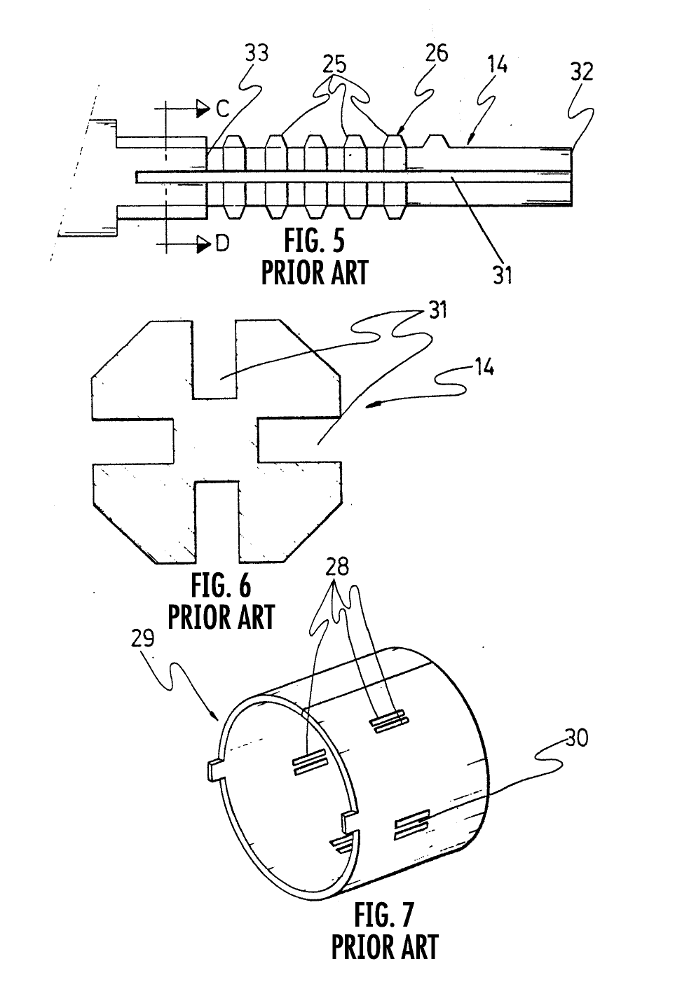

Like reference numerals refer to like parts throughout the several views of the drawings.

### DETAILED DESCRIPTION

The following detailed description is merely exemplary in nature and is not intended to limit the described embodiments or the application and uses of the described embodiments. As used herein, the word “exemplary” or “illustrative” means “serving as an example, instance, or illustration.” All of the implementations described below are exemplary implementations provided to enable persons skilled in the art to make or use the embodiments of the disclosure and are not intended to limit the scope of the disclosure, which is defined by the claims. For purposes of description herein, the terms “upper”, “lower”, “left”, “rear”, “right”, “front”, “vertical”, “horizontal”, and derivatives thereof shall relate to the invention as oriented in the individual figure. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

The following is a detailed description as to the embodiments herein. What is proposed is a deadbolt locking system of the front wheel, friction lock of the back wheel and a combination rack and pinion system of the front and rear wheels.

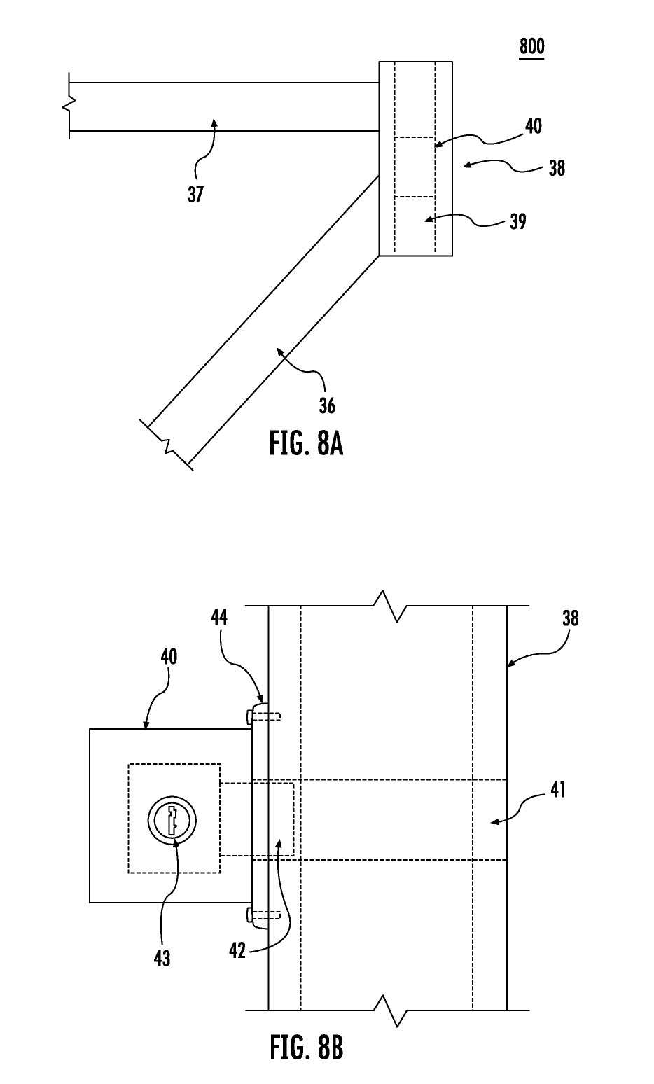

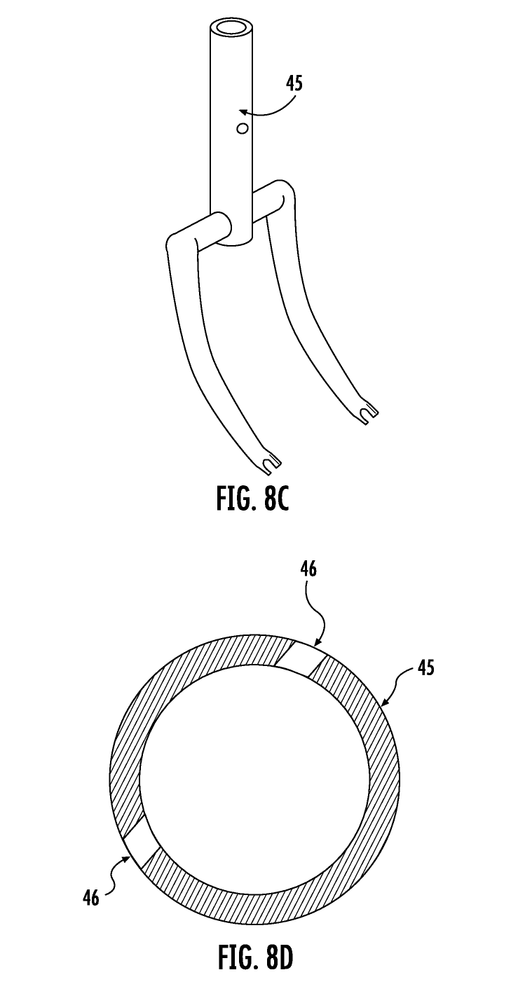

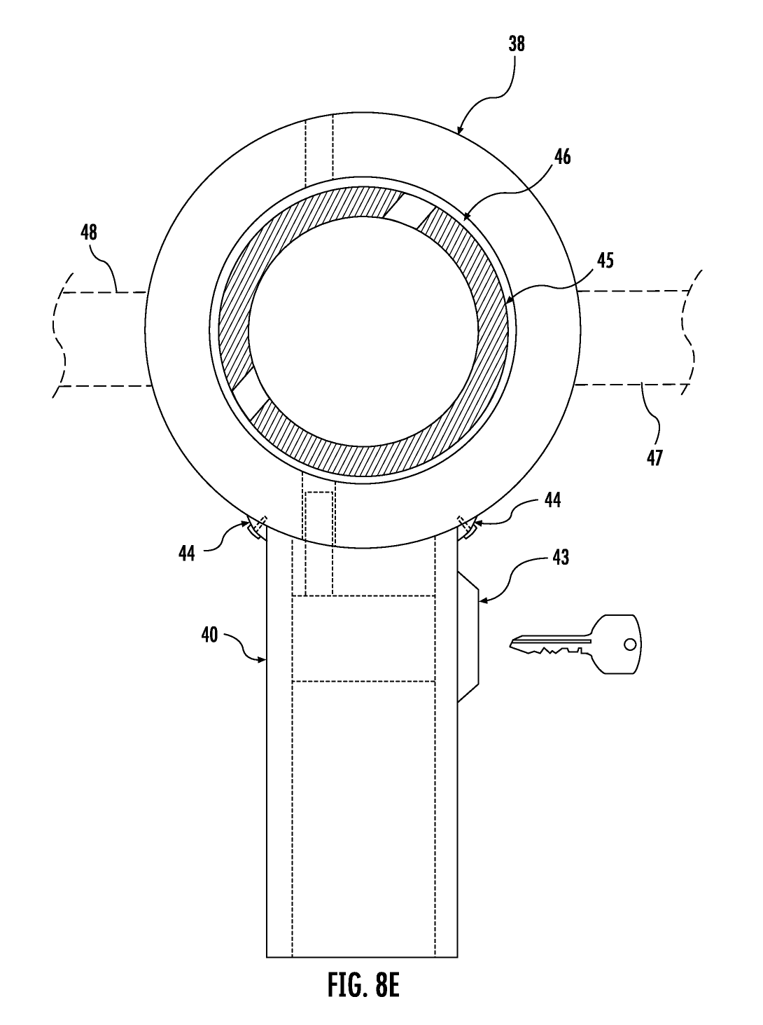

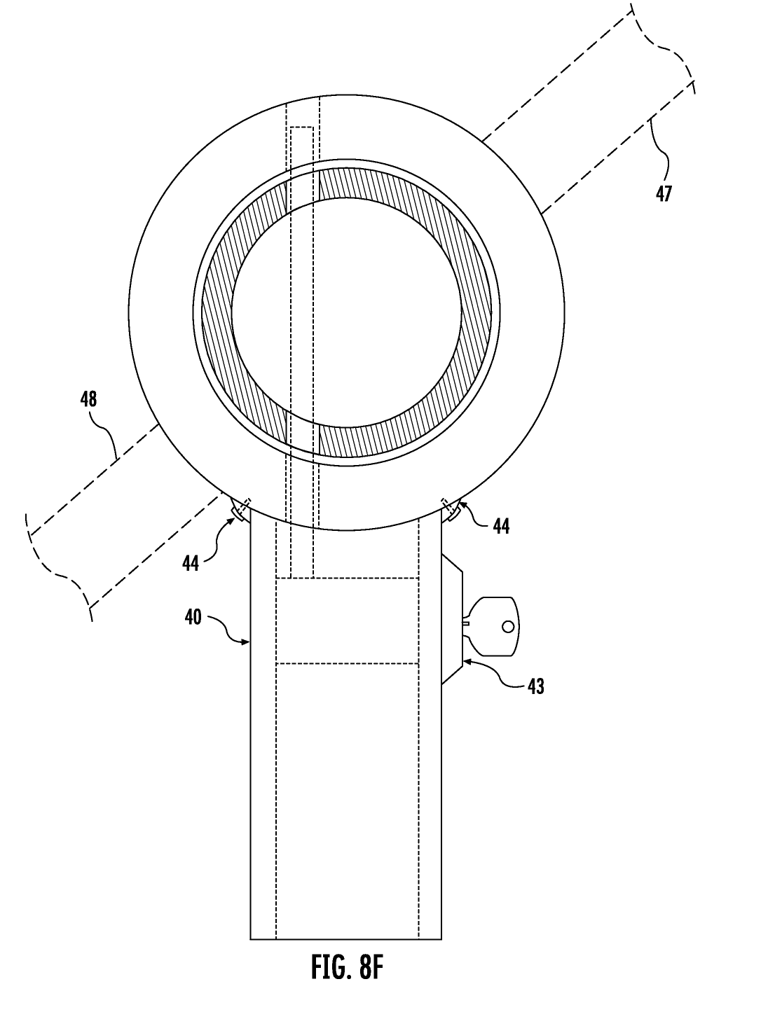

FIG. 8A presents a side view of a novel front lock according to an embodiment. A top tube 37 of a bike is integrated with the an external portion of head tube 38 of a bike as shown; similarly, a down tube of a bicycle is integrated with a side of a bottom portion of a head tube 38. The head tube 38 has a hollow passageway 39 running through it. A deadbolt lock 40 is integrated on the side of the head tube 39 so that it juts out the side of the head tube 39. Optionally, the deadbolt lock 40 is situated underneath the top tube 37 and above the down tube 36 for a more streamlined appearance.

FIG. 8B presents a view of a novel front bike lock according to an embodiment. The bike deadbolt lock 40 is integrated with the side of the head tube 38 using welds or screw locked mounts 44. A key lock 43 is found in the deadbolt lock as shown; locking the system requires the bolt 42 made from a suitable metal to proceed through a cavity in the head tube passing into a central cavity 39 of the head tube 38. Optionally, the other side of the head tube has a depression 41 for reception of the bolt that further strengthens the locking of the bike wheel.

FIG. 8C presents an isometric view of a portion of the tubular structure of the bike having holes for practicing an embodiment. The top tubular portion of the holysmoke 45 has two holes 46 through it arranged in a pair. The holes are arranged offset from the center of the circle such that they are less than 180 degrees apart from the adjacent hole; when set in the bike, the holysmoke 45 is set with a predetermined angle and distance to the first hole 46 from a centerline through a cross section of it. The holes are arranged so that when the wheel of the bike is turned a deadbolt locking mechanism is inserted within the two holes 46 through corresponding holes in the head tube 38.

FIG. 8D shows a top cross section top view of the top portion of the holysmoke 45 according to an embodiment showing corresponding holes 46 offset from the center of the circular holysmoke.

FIG. 8E shows an assembled cross section of the front tubular structure of a novel front bike lock according to an embodiment. A head tube 38 having a hole and a depression therein is concentrically arranged along with a top tubular structure of a holy smoke 45. The holy smoke 45 has two perforations along its surface that permit access from the outside to the shaft or cavity therein. It should be apparent that the holysmoke is arranged with these perforations arranged at a predetermined angle from a pair of axes drawn therein; thus, a plane representing the front bike wheel 48 and bike wheel rear portion 47 are situated at a predetermined number of degrees from the first hole adjacent to that plane. A deadbolt bike lock 40 side integrated in the head tube 38 of a bicycle has a key activated port 43. The deadbolt bike lock 40 has screw mounts with locking screws and or weld points 44; alternatively, the entire device is an integral structure with the head tube. The bolt of the deadbolt lock 40 proceeds through a passageway in the head tube 38 and on through the holes in the holysmoke 45 when extended. The arrangement of the holes thereby avoids the dipstick within the head tube that is not shown but understood to be concentrically arranged therein.

FIG. 8F shows a novel front lock once the bolt or pin has been extended according to an embodiment. In this drawing, the deadbolt has been extended through the perforation in the head tube 38 on through a first perforation in holysmoke 45 through a second perforation therein and on into a depression on the other side of the head tube 38. Optionally, the bolt is only long enough to make it through the second perforation and not into the depression; a final option is that the bolt can only make it through the first perforation. Each of these steps provides less protection but also more flexibility for designers seeking to make changes in bike design.

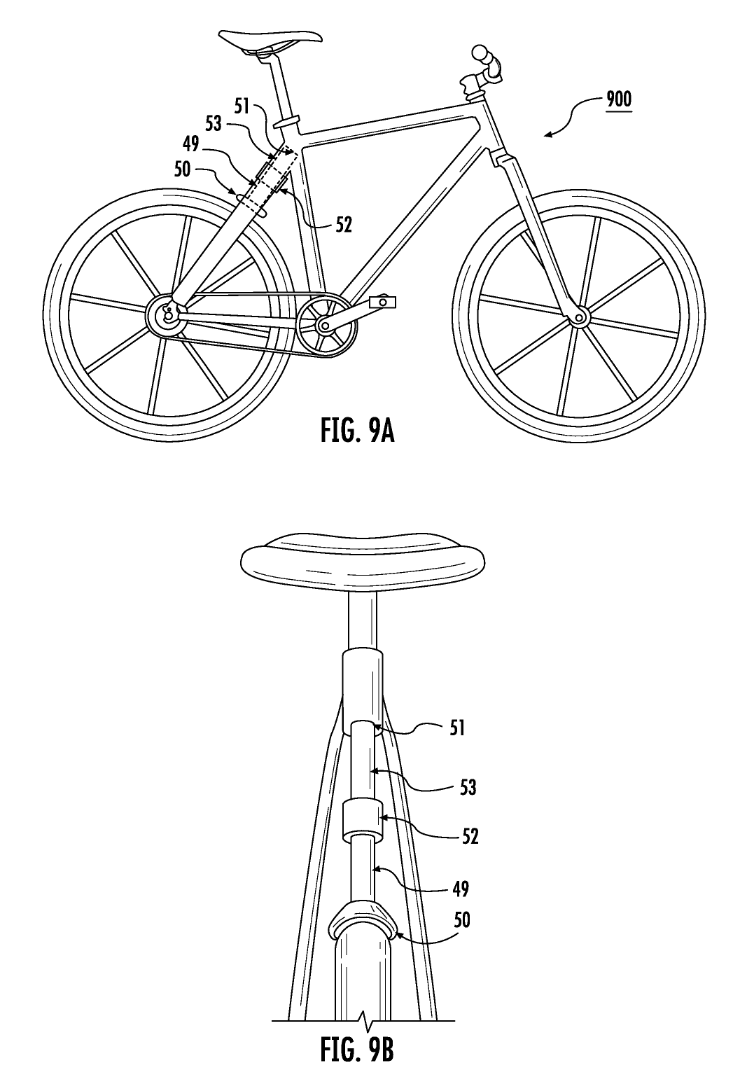

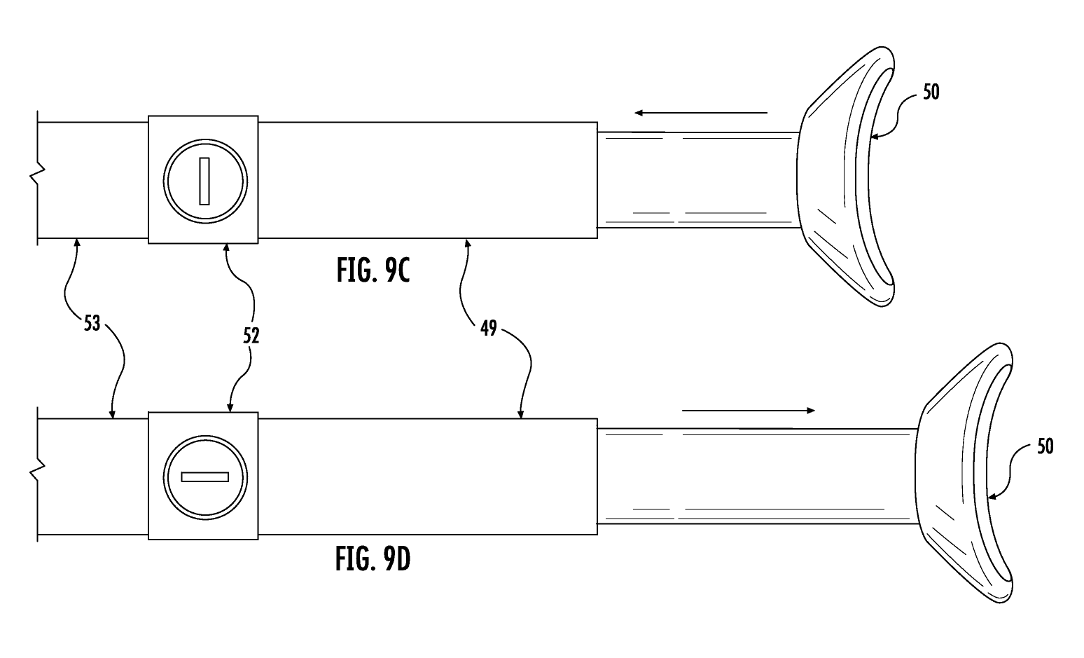

FIG. 9A presents a side view of a novel bicycle rear lock according to an embodiment. A rear locking mechanism 900 is shown attached to a bicycle. A first tubular member 53 or solid rod made from a suitable metal is attached to the rear portion of the bike between the stays at a juncture 51 there between where the two stays become one. This tubular member is attached by welding or screw mounts to a deadbolt key lock mechanism 52. The deadbolt 49 itself proceeds out from the locking mechanism and ends in friction member 50 formed of a rubber material adhesively and mechanically forced onto a T shaped top plate. The rubber material itself has a cut out that closely matches this shape so that it can be mounted thereon.

FIG. 9B illustrates a rear view of a novel rear bike lock according to an embodiment. The tubular member or rod 53 is shown attached to a juncture 51 between the stays. The tubular member or rod is integrated with a deadbolt locking or attached thereto. This locking mechanism has a deadbolt 49 that proceeds out therefrom and ends on a friction rubber member 50 attached to a T shaped end of the deadbolt 49.

FIG. 9C illustrates a retracted bolt locking arm of a novel rear bike lock according to an embodiment. The tubular member or rod 53 is shown attached to a key activated deadbolt mechanism 52 with a retracted deadbolt 49.

FIG. 9D shows an extended bolt locking arm of a novel rear bike lock according to an embodiment. The tubular member or rod 53 is shown attached to a key activated deadbolt mechanism 52 with a extended deadbolt 49.

### Dual Front and Rear Locking Mechanism

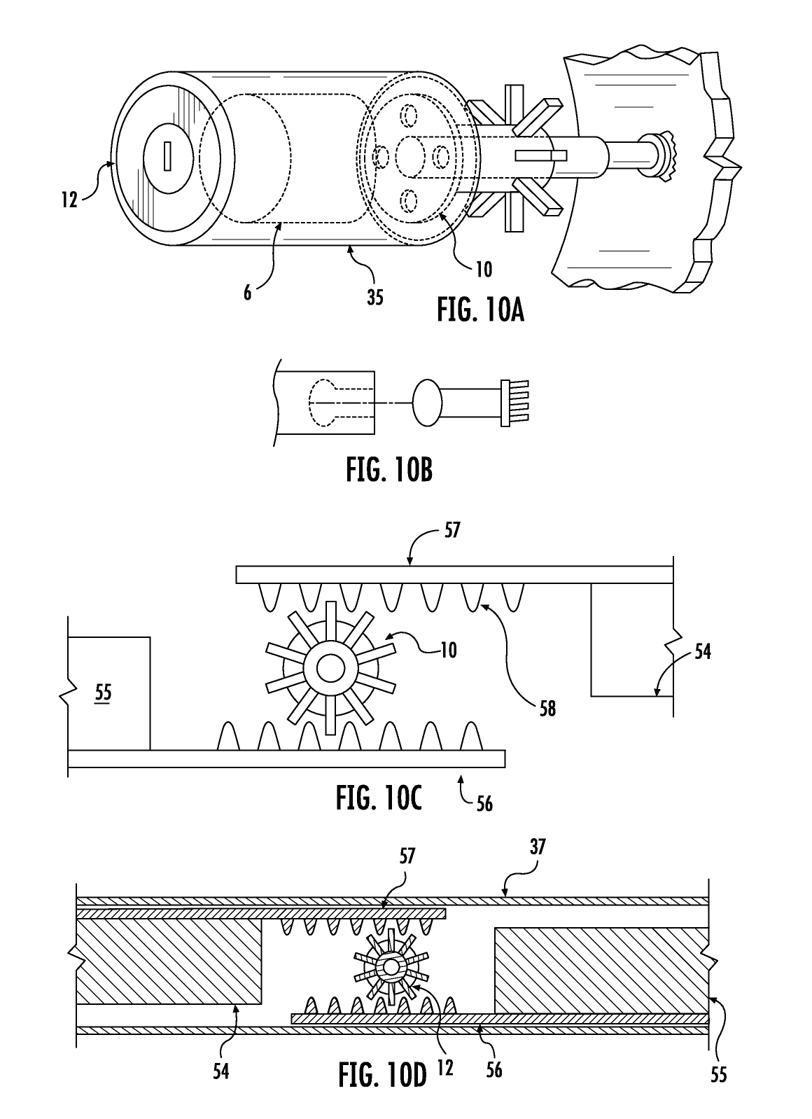

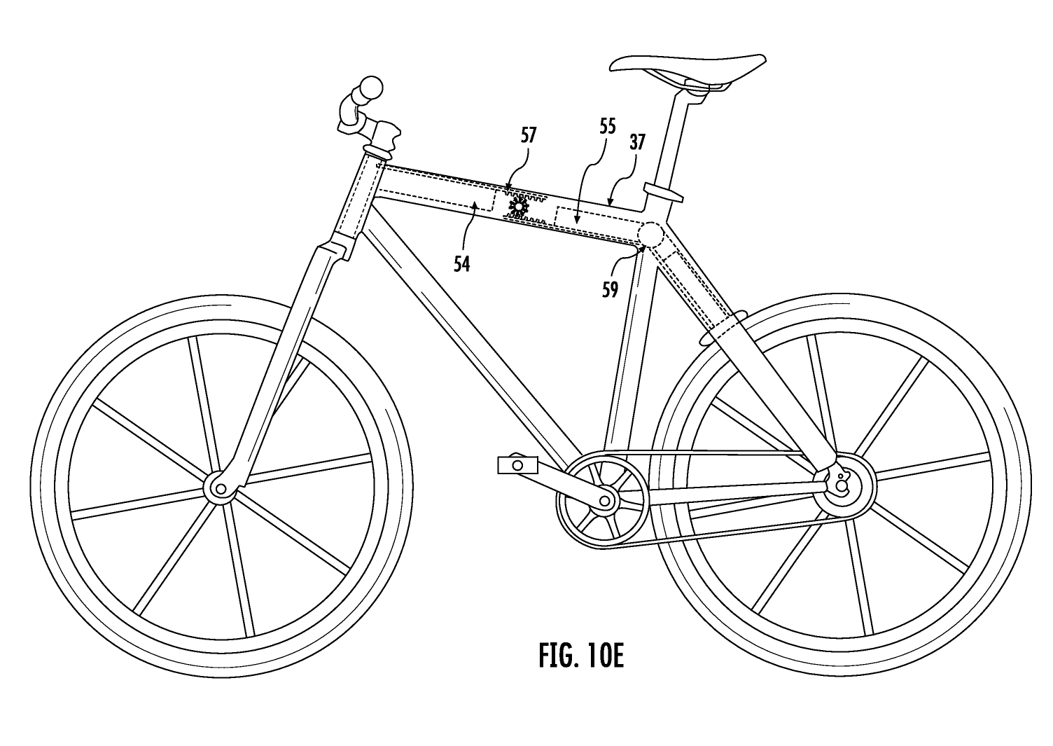

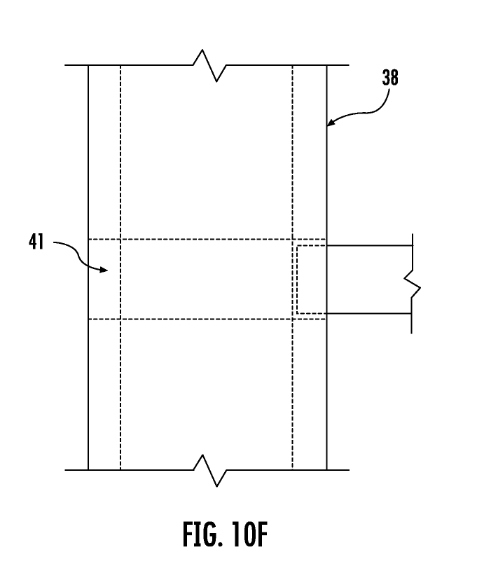

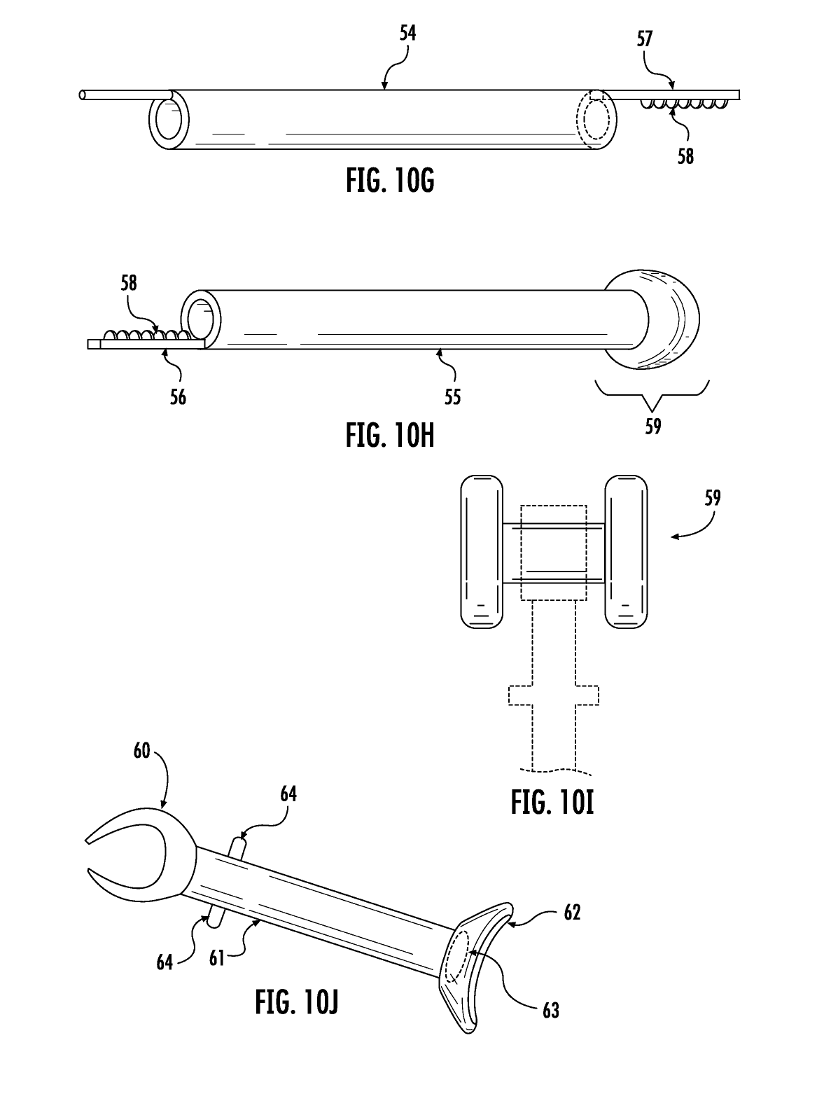

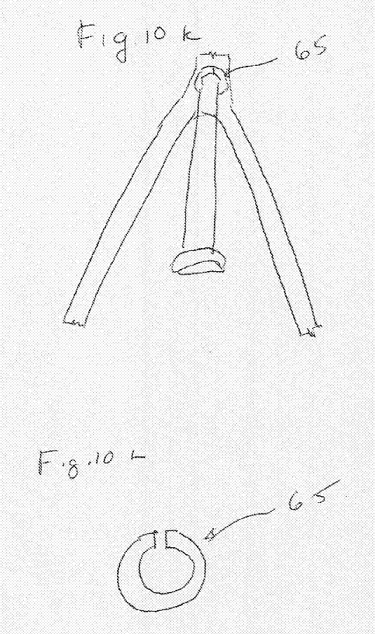

FIG. 10A presents an isometric side view of a barrel of a novel bike lock according to an embodiment showing the toothed gear at the end of the barrel for turning the front and rear racks. Barrel 35 is a cylinder or sleeve that surrounds the mechanisms as taught in the prior art patent EP Application Pub. EP 0 192 467 Published 27.08.86, Application 86301139.1 filed 19.02.86; it should be understood that the teachings found in the background of the invention are herein utilized to make a rotatable bike locking rack and pinion system as taught in the following description. The mechanism of that patent operates the same here except several modifications are made to it so that a bike rack and pinion lock mechanism can be made to work.

FIG. 10B shows a side view of interior side wall of a bike tube having a protrusion forming a rotational axis for the barrel and toothed gear. The sleeve or barrel 35 has its external surface welded into a hole on one side of the top tube 37 of a bike; this prevents the barrel or sleeve from turning. Member 10 is modified to have teeth that rotate in union with support 6 that it is attached to. The back part of the member 10 has a hollow area that closely matches a metal protrusion welded to the inside surface of the top tube; this metal protrusion is welded or integral with the top tube inner surface, at its bottom to the inner surface of the top tube on the opposite side of the hole where is welded the outside of sleeve 35. Using physical force the cylindrical hollow side of member 10 is forced onto this protrusion so that it can rotate thereon.

FIG. 10C illustrates a right side view of a set of front and rear racks of a novel bike lock according to an embodiment. Rotating member's 10 teeth are arranged within two sets of teeth 58 disposed on two toothed racks 56, 57; in this fashion the rotation of the member 10 acts as a pinion to move the top and bottom racks 56, 57. The toothed racks are metal rods horizontally extending from two other metal rods 54, 55 or cylinders that operate within the top tube to open and close a dual operating locking mechanism.

FIG. 10D shows a left cross section view of a set of front and rear racks inside a top tube of a novel bike lock according to an embodiment. The top tube 37 of a bicycle has two toothed racks 56,57 that are metal rods horizontally extending from two other metal rods 54, 55 or cylinders that operate within the top tube to open and close a dual operating locking mechanism.

FIG. 10E shows a left cross section side view of a bike showing the rack mechanism inside of a top tube for a novel bike lock according to an embodiment. This view further shows how the rear cylinder or rod 55 extends toward a hole between the stays at the rear end of the bicycle. The rod or cylinder 55 ends in a joint 59 that has recesses for holding a curved swivel mechanism that actuates the friction brake at the back end of the bicycle.

FIG. 10F shows a front bolt lock of a novel bike lock according to an embodiment as the locking mechanism enters the front tube walls. A bolt or pin integrally formed form cylinder or rod 54 proceeds parallel and out therefrom at its front portion. When a key is turned opening the locking mechanism situated in the midst of the top tube the lock activates the sliding mechanism within the top tube moving the rack forward. Then, the pin or bolt enters a hole in the head tube and further on into the first perforation in the holy smoke thus locking the bike in place. It can proceed further to a depression 41 on the other side of the tube as in the front lock embodiment of FIG. 8D-F.

FIG. 10G illustrates a left side isometric view of tubular device having a rack used to create a front lock according to an embodiment. The tubular device 54 has a rack 57 at one end having teeth 58 and a pin or bolt at the other end jutting forwards and in parallel with the rest of the device 54.

FIG. 10H shows a left side isometric view of a tubular device having a rack used to make a rear lock in combination with a friction member according to an embodiment. The tubular device 55 or rod has a rack 56 disposed on its forward portion having a set of teeth 58. At the other end or rear portion of the tubular member 55 there is a fixed hinge set between two holders 59. The two holders are integrated with the fixed hinge or swivel point 59.

FIG. 10I is a swivel joint for a rear friction lock according to an embodiment. FIG. 10I is a swivel joint or juncture having two sides and a hinge there between. The two portions of the juncture 59 are integrated with the hinge axis fixed there between.

FIG. 10J is a side view of a friction member according to an embodiment. Braking member 61 is primarily formed of a rod or hollow metallic member having a T-shaped end 63 at one end. This T-shaped member 63 is surrounded by a rubber portion that is adhesively and physically locked in place thereon to make frictional contact with the rear tire of a bike. On the other side of braking member 61 is a curved swivel joint or mechanism that has two protruding curves that are welded together at manufacture. Of course the welding happens after the jaw formed by the two curves has been loaded onto the hinge 59 located at the end of cylinder or rod 55; the two ends are brought together and welded together at that time.

Finally, stops 64 are found on opposite sides of the braking member 61; these are protrusions that act in combination with a locking plate 65 to ensure that the member 61 can proceed no further outside of top tube 37. The locking plate is a simple piece of metal having a perforation that permits the member 61 to slide therethrough but does not permit it to proceed further then stops 64. The locking plate is made from a strip of material that is cut, bent and situated about member 61 ahead of the stops 64 then bent again into place and all ends are welded together and the edges thereof are welded to the perforation's edges between the stays. Of course, another solution envisions two precut pieces of material being brought together and welded to the perforation between the stays after loading the member and other components into place.

All components are metallic unless otherwise indicated; further, suitable replacement materials having properties similar to metals can also be utilized. The above described embodiments are merely exemplary illustrations of implementations set forth for a clear understanding of the principles of the invention. Many variations, combinations, modifications or equivalents may be substituted for elements thereof without departing from the scope of the invention. Therefore, it is intended that the invention not be limited to the particular embodiments disclosed as the only modes contemplated for carrying out this invention, but that the invention will include all the embodiments falling within the scope of the appended claims.

1. A bicycle locking system comprising:
a bike having
a head tube having a hole perforating a side thereof as well as
a corresponding depression on an inner surface of the head tube opposite the hole in the head tube
a tubular member concentrically located within the head tube and rotationally moveable associated therewith and
a dead bolt lock attached to the exterior of the head tube for extension of a deadbolt locking mechanism through the hole and into the corresponding depression.

2. The bicycle locking system of claim 1, wherein the hole and the corresponding depression are offset from a centerline of the head tube.

3. (canceled)

4. (canceled)

5. (canceled)

6. (canceled)

7. (canceled)

8. (canceled)

9. (canceled)

10. A bike locking mechanism comprising:
a bike having a top tube and two stays integrally associated with a back end of the top tube
a member attached between the two stays at a juncture there between wherein the member has a deadbolt locking mechanism integrally associated therewith and
a moveable deadbolt associated with the deadbolt locking mechanism having
a frictional end portion thereof.

11. (canceled)

12. (canceled)

13. (canceled)

14. (canceled)

15. A bike locking apparatus comprising:
a bike having
a head tube having a hole perforating a side thereof as well as
a corresponding depression on an inner surface of the head tube opposite the hole in the head tube
a tubular member concentrically located within the head tube and rotationally moveable associated therewith and
a dead bolt lock attached to the exterior of the head tube for extension of a deadbolt locking mechanism through the hole and into the corresponding depression
wherein the bike has a top tube and two stays integrally associated with a back end of the top tube
a second member attached between the two stays at a juncture there between—wherein the second member has a deadbolt locking mechanism integrally associated therewith and
a moveable deadbolt associated with the deadbolt locking mechanism having
a frictional end portion thereof.

16. The bike locking apparatus of claim 15, wherein the hole and the corresponding depression are offset from a centerline of the head tube.

17. (canceled)

18. (canceled)

19. (canceled)

20. (canceled)
